(19) United States
(12) Patent Application Publication
(10) Pub. No.: US 2010/0041830 A1
(43) Pub. Date: Feb. 18, 2010

(54) TOUGHENED POLYAMIDE COMPOSITIONS

(75) Inventor: Edmund Arthur Flexman, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/610,528

(22) Filed: Nov. 2, 2009

Related U.S. Application Data
(63) Continuation-in-part of application No. 12/313,481, filed on Nov. 20, 2008.
(60) Provisional application No. 61/005,072, filed on Nov. 30, 2007.

(51) Int. Cl. C08L 33/04; C08L 77/00

(52) U.S. Cl. 525/183; 525/420

(57) ABSTRACT

Polyamides containing repeat units derived from about 10 to about 35 weight percent 1,6-diaminohexane and terephthalic acid, up to 10 weight percent of other polyamide repeat units, and the remainder of the repeat units derived from 1,6-diaminohexane and adipic acid may be toughened with exceptionally small amounts of rubber tougheners, to give compositions which are especially tough. The resulting compositions are useful for industrial, consumer, electronics, and automotive parts.

### CROSS REFERENCE TO RELATED APPLICATIONS

This application is a continuation-in-part of application Ser. No. 12/313,481, filed Nov. 20, 2008 and claims the benefit of U.S. Provisional Application No. 61/005,072, filed Nov. 30, 2007.

### FIELD OF THE INVENTION

Polyamides containing repeat units derived from 1,6-diaminohexane and terephthalic acid, and 1,6-diaminohexane and adipic acid, in specified proportions, may be toughened with exceptionally small amounts of rubber tougheners, to give compositions which are especially tough.

### TECHNICAL BACKGROUND

So-called “engineering polymers”, including polyamides, are important items of commerce, being used extensively for many different types of parts in for instance automotive, electrical and industrial uses. In some cases the polymers themselves are too brittle and so must be toughened. This is commonly achieved by mixing into the polyamide or other engineering polymer a “rubber toughener”, see for instance U.S. Pat. No. 4,174,358.

Toughness of such compositions is often measured by some standard test such as the Notched Izod test (ASTM D256). Generally speaking the higher the values obtained in this test the tougher the material is considered. Another important indicator of toughness is whether, during a test such as the Notched Izod test, the break in the composition caused by the test appears to be ductile or brittle. To reliably be tough enough it is preferred that all or almost all of the repetitions of such testing display ductile breaks. Sometimes the mere recitation of average toughness values obtained in Notched Izod testing may be deceiving if many of the breaks are brittle breaks, since this is undesirable.

Similar to many property “improvements” to thermoplastic compositions, addition of the toughener often results in the diminution of other desirable properties, so tradeoffs in properties are usually made. For instance addition of the rubber toughener usually results in lowering of the tensile and flexural moduli and heat resistance of the compositions. Since this affects part stiffness, sometimes the parts have to be made larger to compensate for the loss in modulus, incurring an economic penalty. Therefore improved compositions containing toughened polyamides are desired.

### SUMMARY OF THE INVENTION

There is disclosed and claimed herein a composition comprising:

(a) 80 to 98 percent by weight of a polyamide consisting essentially of 10 to 35 repeat unit weight percent of the formula

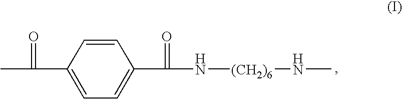

0 to 10 repeat unit weight percent of one or more repeat units of the formula

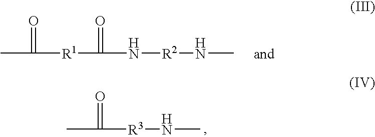

wherein R¹, R² and R³ are each independently hydrocarbylene or substituted hydrocarbylene, wherein R¹ is not 1,4-phenylene and/or R² is not —(CH₂)₆—,

and the remainder of the repeat units are of the formula

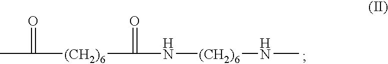

(b) 2 to 20 percent by weight of a polymeric toughener containing a re-active functional group and/or a metal salt of a carboxylic acid;

provided that each of (III) and (IV) are different than (I) and (II); and

wherein said weight percents are based on the total amount of (a) and (b) present in said composition, and said repeat unit weight percents are based on the total weight of (I), (II), (III) and (IV) present.

Also described are shaped parts of this composition.

### DETAILS OF THE INVENTION

By “hydrocarbylene” is meant a group (radical) containing carbon and hydrogen having two free (single bond) valencies from two different carbon atoms. Exemplary hydrocarbylene groups include 1,10-decylene, 1,3-butylene, 2-methyl-1,5-pentylene, 1,4-phenylene, 1,8-naphthylene, 4,4′-biphenylene, and 1,3-phenylene.

By “substituted hydrocarbylene” is meant hydrocarbylene substituted with one or more functional groups that do not interfere with formation of the polyamide using the particular polyamide synthesis method chosen. Exemplary substituent groups include ether, halo, and tertiary amino.

By a “reactive functional group” is meant a group which normally reacts with a complimentary reactive group which is part of the polyamide, particularly during melt forming and/or melt processing of the polyamide composition. Typically the complimentary functional group on the polyamide is carboxyl and/or amino end groups, but may be other groups which are either grafted onto the polyamide or are originally polymerized into the polyamide as part of relatively small amounts of comonomers that contain the complimentary functional group. Typical reactive functional groups are epoxy, carboxyl, carboxylic anhydride, isocyanato, and keto. Preferred reactive functional groups are carboxyl, carboxylic anhydride, and epoxy.

The polymeric toughener is a polymer, typically which is an elastomer or has a relatively low melting point, generally <200° C., preferably <150° C., which has attached to it reactive functional groups which can react with the polyamide. Such functional groups are usually “attached” to the polymeric toughener by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber (such as an ethylenela-olefin copolymer, an a-olefin being a straight chain olefin with a terminal double bond such a propylene or α-octene) using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl(meth)acrylate. In addition to ethylene and a difunctional (meth)acrylate monomer, other monomers may be copolymerized into such a polymer, such as vinyl acetate, unfunctionalized (meth)acrylate esters such as ethyl(meth)acrylate, n-butyl(meth)acrylate, i-butyl(meth)acrylate and cyclohexyl(meth)acrylate. Preferred tougheners include those listed in U.S. Pat. No. 4,174,358, which is hereby included by reference. Especially preferred polymeric tougheners are copolymers of ethylene, ethyl acrylate or n-butyl acrylate, and glycidyl methacrylate.

Another type of group which may be attached to the polymeric toughener is a metal salt of a carboxylic acid salt. Such polymers made be made by grafting or by copolymerizing a carboxyl or carboxylic anhydride containing compound to attach it to the polymer. Useful materials of this sort include Surlyn® ionomers available from E. I. DuPont de Nemours & Co. Inc., Wilmington, Del. 19898 USA, and the metal neutralized maleic anhydride grafted ethylene/α-olefin polymer described above. Preferred metal cations for these carboxylate salts include Zn, Li, Mg and Mn.

It is preferred that the polymeric toughener contain a minimum of about 0.5, more preferably 1.0, very preferably about 2.5 weight percent of repeat units and/or grafted molecules containing functional groups or carboxylate salts (including the metal), and a maximum of about 15, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the polymeric toughener, and/or more than one polymeric toughener. In one embodiment the polymeric toughener comprises about 2.5 to about 10 weight percent of repeat units and/or grafted molecules containing functional groups or carboxylate salts (including the metal).

It has been found that often the toughness of the composition is increased by increasing the amount of polymeric toughener and/or the amount of functional groups and/or metal carboxylate groups. However, these amounts should preferably not be increased to the point that the composition may crosslink (thermoset), especially before the final part shape is attained, and/or the first to melt tougheners may crosslink each other. Increasing these amounts may also increase the melt viscosity, and the melt viscosity should also preferably not be increased so much that molding is made difficult. Non-functional tougheners (elastomers) may also be present in addition to functionalized toughener. Such nonfunctional tougheners include polymers such as ethylene/α-olefin/diene (EPDM) rubber, ethylenela-olefin (EP) rubber, and ethylene/1-octene copolymer.

The minimum amount of polymeric toughener is 2, preferably 6, and more preferably about 8 weight percent, while the maximum amount of polymeric toughener is about 20, preferably about 15 and more preferably about 12 weight percent. It is to be understood than any minimum amount may be combined with any maximum amount to form a preferred weight range. One embodiment includes about 6 weight percent to about 12 weight percent polymeric toughener.

The polymeric toughener and/or nonfunctional toughener is preferably a rubber (its melting point and/or glass transition points are below 25° C.) or is somewhat rubber-like, i.e., has a heat of melting (measured by ASTM Method D3418-82) of less than about 10 J/g, more preferably less than about 5 J/g, and/or has a melting point of less than 80° C., more preferably less than about 60° C. Preferably the polymeric toughener has a weight average molecular weight of about 5,000 or more, more preferably about 10,000 or more, when measured by gel permeation chromatography using polyethylene standards.

Useful polymeric tougheners include:
(a) A copolymer of ethylene, glycidyl(meth)acrylate, and optionally one or more (meth)acrylate esters. p1 (b) An ethylene/α-olefin or ethylene/α-olefin/diene (EPDM) copolymer grafted with an unsaturated carboxylic anhydride such as maleic anhydride.
(c) A copolymer of ethylene, 2-isocyanatoethyl(meth)acrylate, and optionally one or more (meth)acrylate esters.
(d) a copolymer of ethylene and acrylic acid reacted with a Zn, Li, Mg or Mn compound to form the corresponding ionomer.

In the polyamide the (I) repeat units can also be referred to as 6T repeat units, that is, arising from the polymerization of hexamethylene diamine (6) and terepthallic acid (T), or a derivative thereof. In the polyamide the minimum amount of (I) repeat units is about 10, preferably about 15, more preferably about 20 weight percent, while the maximum amount of (I) repeat units is about 35, preferably about 30, more preferably about 28 weight percent. It is to be understood that any minimum value may be combined with any maximum value to form a preferred weight percent range.

The polyamide may contain up to about 10 weight percent one or more of (III) and/or (IV). Preferably it contains up to about 5 weight percent of (II) and/or (IV), more preferably consists essentially of (“consists essentially of” herein refers to the property of toughening the polyamide using relatively small amounts of toughener) repeat units (I) and (II), and especially preferably consists of repeat units (I) and (II).

The polyamide may be made by methods well known in the art, see for instance M. I. Kohan Ed., Nylon Plastics Handbook, Hanser/Gardner Publications, Inc., Cincinnati, 1995, p. 17-23, which is hereby included by reference. Preferably the polyamide has a number average molecular weight of at least about 5,000, when measured by Gel Permeation Chromatography using polyethylene standards.

The composition may contain other ingredients other than those described above, especially those commonly found in polyamide compositions, typically in the concentrations usually used. These types of ingredients include fillers, reinforcing agents, antioxidants, stabilizers, pigments, mold release, lubricant, etc.

The composition may be made by methods known in the art for making “rubber” toughened thermoplastic compositions. Typically the polyamide is melt mixed with the polymeric toughener in a suitable device such as a twin screw extruder or a kneader. The amount of work (shear) to which these ingredients are subject to are will affect the final properties of the composition, especially toughness. Generally speaking the higher the shear applied to the composition (without significant degradation from shear heating) the tougher the composition will be for the amount of toughener used. Also generally speaking, the higher the amount of toughener used, the tougher (more rubber-like) the composition will be, but also the lower the modulus of the composition (see above). Oftentimes the minimum toughness goal is to consistently achieve ductile breaks (as opposed to brittle breaks) in whatever toughness test is being used, using the minimum amount of polymeric toughener possible so as to lower the composition modulus as little as possible. It is also noted that for many types of polymeric tougheners that, up to a point, the higher the amount of functional group or carboxylate metal salt group present the more efficient the toughener acts to toughen the composition. Those skilled in the area of toughening polymers understand these parameters and how they affect final composition properties. In addition the Examples herein describes specific conditions for forming their respective compositions.

During the melt mixing described above other ingredients, as described above may also be added to the polyamide and polymeric toughener being mixed They may be added as the rear of the mixing apparatus, or somewhere downstream of that to prevent their being degraded by excessive shear.

The toughened polyamide compositions described herein may be molded into shaped parts by a variety of methods, usually melt forming methods, such as injection molding, extrusion, thermoforming, compression molding, rotomolding, and blow molding (of all types). These parts are useful in automotive, industrial, electrical and electronic, and consumer applications. Exemplary applications include cable ties, sporting goods such as snow boards, fire extinguisher valves, automotive parts such as emission canisters and roof racks, power tool housings, and appliance components such as impeller fans and bag clips.

### Example 1 and Comparative Examples A-C

The following mixtures of pellets of the appropriate polymers and the antioxidant were fed to the rear of a 30 mm co-rotating twin screw extruder fitted with a moderately hard working screw consisting of three sets of kneading blocks followed by a reverse upstream of the vacuum port followed by a single left handed reverse between the die and vacuum port. All were run at 300 rpm with a 13.6 kg/h feed rate. The barrel temperatures were set at 270° C. for Example 1 and Comparative Example A, and because of the higher melting points of the polyamides, the barrel temperatures were set to 290° C. and 320° C. for Comparative Examples B and C, respectively. The hand melt temperatures were 321, 319, 326, and 355° C. for Examples 1, A, B, and C, respectively. The compositions were pelletized after exiting the extruder.

After drying in a vacuum oven with a slight nitrogen bleed at ˜100° C. overnight, the pellets were injection molded in a 6 ounce reciprocating molding machine into a mold producing one ASTM ⅛″ tensile bar and two 127 mm long×13 mm wide×3.2 mm (⅛″) thick rectangular bars per shot. All cycle times were 2 second boost, 20 second inject (pressure), and 10 second cool. Examples 1 and A had measured mold temperatures averaging 92° C., Example B 138° C. and Example C was 158° C. The actual barrel temperatures rear/center/front/nozzle were 2701269/2691264, 2731270/2701269, 290/299/298/292, and 320/333/3321320° C. for Examples 1 A, B and C, respectively. Bars were vacuum sealed in foil lined plastic bags to preserve them in the dry as molded condition until there were cut and immediately tested. The dry as molded state is the most brittle condition for polyamides since moisture absorbed from the atmosphere acts like a plasticizer improving toughness and ductility.

Ten (⅛″) 3.2 mm thick bars of each were cut in half and the near to the gate and far from the gate halves notched and tested according to the ASTM D256 Notched Izod test, Test Method A, with the exceptions noted above The maximum energy (capacity) of the pendulum was 5.5 J. The average of the 20 impacts is listed in Table 1, along with the averages of the 10 each near and far impacts, and the number of brittle breaks overall.

For Example 1 and Comparative Examples A, B and C, the compositions contain (all parts by weight) 92 parts of polyamide, 8 parts of a toughener which was an ethylene/octane copolymer grafted with 2.6 weight percent maleic anhydride (with a melt index of 0.75), and 0.2 parts of Irganox® 1010 (an antioxidant available from Ciba Specialty Chemicals, Inc., Basel, Switzerland). The polyamides used were as follows:

### Example 1

A copolyamide of 1,6-hexanediamine, terephthalic acid, and adipic acid in which terephthalic acid was 25 weight percent of the dicarboxylic acid present.

### Comparative Example A

Zytel® 101, a polyamide made from 1,6-hexandiamine and adipic acid (PA 6,6), available from E.I. DuPont de Nemours & Co., Inc. Wilmington Del. 19898 USA.

### Comparative Example B

A copolyamide of 1,6-hexanediamine, terephthalic acid, and adipic acid in which terephthalic acid was 40 weight percent of the dicarboxylic acid present.

### Comparative Example C

A copolyamide of 1,6-hexanediamine, 2-methyl-1,5-pentanediamine and terephthalic acid in which 1,6-hexanediamine is 50 weight percent of the total diamine present.

Comparison of Example 1 with Comparative Examples A-C show that Example 1, having 25 weight percent 6T repeat units, has surprising and unexpected improvement in Notched Izod performance. Comparative Example A having PA 6,6 exhibits much lower Notched Izod than Example 1 and all breaks are brittle.

Comparative Example B, having 40 weight percent 6T repeat units exhibits much lower Notched Izod than Example 1 and all breaks are brittle. This indicates that polyamides having a narrowly defined range of 6T repeat units exhibit a high degree of toughening at a given level of toughener.

TABLE 1

| | Notched Izod, N · m/m | | | # Brittle |
|---|---|---|---|---|
| Example | Overall | Near | Far | breaks |
| 1 | 881 | 732 | 1025 | 0 |
| A | 246 | 230 | 278 | 20 |
| B | 208 | 176 | 246 | 20 |
| C | 155 | 134 | 182 | 20 |

### Example 2

Using the same procedure as Example 1, and the polyamide of Example 1, the polyamide was mixed with 5% of the toughener used in Example 1 except the toughener was grafted with 4.3 weight percent of maleic anhydride. Overall Notched Izod was 235 N·m/m. All 10 of the breaks were brittle.

### Example 3

Using the same procedure as Example 1, and the polyamide of Example 1, the polyamide was mixed with 10% of the toughener used in Example 1 except the toughener was grafted with 3.9 weight percent of maleic anhydride. Overall Notched Izod was 892 N·m/m. None of the 10 breaks were brittle.

### Example 4

Using the same procedure as Example 1, and the polyamide of Example 1, the polyamide was mixed with 10% Kraton® FG1901X, reportedly a triblock polymer based on styrene and ethylene/butylene, with a 30% styrene content and containing 1.4-2.0 weight percent bound maleic anhydride, available from Kraton Polymers LLC, Houston Tex. 77032, USA. Overall Notched Izod was 235 N·m/m. All 10 of the breaks were brittle.

### Example 5

Using the same procedure as Example 1, and the polyamide of Example 1, the polyamide was mixed with 5% of Surlyn® ionomer, reportedly an ethylene/methacrylic acid copolymer partially neutralized with zinc ions, available from E.l. DuPont de Nemours & Co., Inc, Wilmington, Del. 19898 USA. Overall Notched Izod was 150 N·m/m All 10 of the breaks were brittle.

1. A composition comprising:
(a) 80 to 98 percent by weight of a polyamide consisting essentially of 10 to 35 repeat unit weight percent of the formula 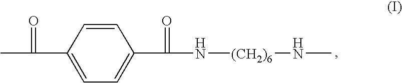
0 to 10 repeat unit weight percent of one or more repeat units of the formula 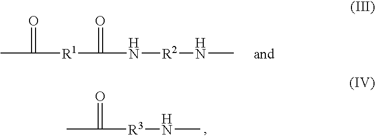
wherein R¹, R² and R³ are each independently hydrocarbylene or substituted hydrocarbylene, wherein R¹ is not 1,4-phenylene and/or R² is not —(CH₂)₆—, and the remainder of the repeat units are of the formula 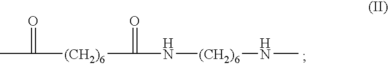
(b) 2 to 20 percent by weight of a polymeric toughener containing a re-active functional group and/or a metal salt of a carboxylic acid;
provided that each of (III) and (IV) are different than (I) and (II); and
wherein said weight percents are based on the total amount of (a) and (b) present in said composition, and said repeat unit weight percents are based on the total weight of (I), (II), (III) and (IV) present in said polyamide.

2. The composition as recited in claim 1 wherein said polymeric toughener contains 2.5 to about 10 weight percent of repeat units containing said functional group and/or a metal salt of a carboxylic acid.

3. The composition of claim 1 wherein said polymeric toughener is about 6 weight percent to about 12 weight percent of said composition.

4. The composition of claim 1 wherein said polymeric toughener comprises about 2.5 to about 10 weight percent of repeat units and/or grafted molecules containing a reactive functional group and/or a metal salt of a carboxylic acid.

5. The composition as recited in claim 1 wherein said repeat unit (1) is about 20 to about 30 weight percent of said polyamide.

6. The composition as recited in claim 1 wherein said polymeric toughener is one or more selected from the group consisting of: a copolymer of ethylene, glycidyl (meth)acrylate, and optionally one or more (meth)acrylate esters; an ethylenela-olefin or ethylene/a-olefin/diene copolymer grafted with an unsaturated carboxylic anhydride; a copolymer of ethylene, 2-isocyanatoethyl(meth)acrylate, and optionally one or more (meth)acrylate esters; and a copolymer of ethylene and acrylic acid reacted with a Zn, Li, Mg or Mn compound to form the corresponding ionomer.

7. The composition of claim 4 wherein said repeat units (III) and (IV) are not present.

8. The composition of claim 1 wherein said polyamide consists essentially of repeat units (I) and (II).

9. A shaped part comprising the composition of claim 1.

10. A shaped part of the composition of claim 5.
